(19) United States
(12) Patent Application Publication
(10) Pub. No.: US 2010/0008038 A1
(43) Pub. Date: Jan. 14, 2010

(54) Apparatus and Method for Reliable and Efficient Computing Based on Separating Computing Modules From Components With Moving Parts

(76) Inventor: Giovanni Coglitore, Saratoga, CA (US)

Correspondence Address: COOLEY GODWARD KRONISH LLP;ATTN: Patent Group, Suite 1100, 777 - 6th Street, NW, WASHINGTON, DC, 20001, US

(21) Appl. No.: 12/465,542

(22) Filed: May 13, 2009

Related U.S. Application Data
(60) Provisional application No. 61/053,381, filed on May 15, 2008.

(51) Int. Cl. G06F 1/16; G06F 1/20

(52) U.S. Cl. 361/679.48; 361/679.02

(57) ABSTRACT

A computing apparatus is described. In one embodiment, the apparatus includes a chassis, a plurality of computing modules fixedly mounted in the chassis, and solid state electronic components in each of the plurality of computing modules, wherein any components with moving parts are exterior to the chassis.

### CROSS-REFERENCE TO RELATED APPLICATION

The present application claims the benefit of the following commonly owned U.S. provisional patent application, which is incorporated herein by reference in its entirety: U.S. Provisional Patent Application No. 61/053,381, Attorney Docket No. RACK-020/00US, entitled “Apparatus and Method for Reliable and Efficient Computing,” filed on May 15, 2008.

### FIELD OF THE INVENTION

The present invention relates generally to the manner in which groups of computers are designed, configured, and installed in a given area. More particularly, this invention relates to grouping and combining components traditionally distributed across multiple computer servers to provide the performance of multiple computer servers with increased reliability and efficiency.

### BACKGROUND OF THE INVENTION

As information technology has rapidly progressed, computer network centers such as server farms and server clusters have become increasingly important to our society. The server farms provide efficient data processing, storage, and distribution capability that supports a worldwide information infrastructure, which has come to alter how we live and how we conduct our day to day business.

Typically, at a site where numerous computers are connected to a network, the computers and related equipment are stacked in racks, which are arranged in repeating rows. In conventional systems, the racks are configured to contain computer equipment having a standard size in compliance with the Electronic Industries Alliance (EIA) “rack unit” or “U” standard. Each computer would have a height of 1U, 2U, or some U-multiple, with each U corresponding to approximately 1.75″.

A standard rack that is widely used measures roughly 19 inches wide, 30 inches deep and 74 inches high. These racks may be arranged in rows of, for example, roughly 10-30 units, with access doors on each side of the racks. Access aisles are provided on both sides of the rows so that an operator may approach the access doors on each side. Many of the racks are filled with cumbersome computers mounted on sliders which are attached through mounting holes provided in the front and back of the rack.

In conventional rack-based computer systems, a plurality of computers are often supported in a single stack in a rack. The rack may include a cabinet assembly having a front door and a back door. Each of the computers typically includes a computer chassis having a motherboard and other components, such as one or more power supplies, hard drives, processors, and expansion cards contained within the chassis. The front door of the cabinet assembly provides access to the front sides of the computers and the back door provides access to the back sides, where the I/O ports for the computer are typically provided. Each computer may also include one or more fans that draw ambient air into vents provided on one side of the computer, through the computer chassis, and out of vents provided on the opposite side of the computer. The ambient air passing through the computers is used to cool the various components contained within the computer chassis. Each computer also typically attains connectivity with the outside world, such as via the Internet and/or a local or wide area network, through a network connection to the rack. The rack may provide a switch module to which each computer connects.

In recent years, server farms have been used to combine and to coordinate the processing power of multiple individual computer servers. Each computer server set up in a farm or otherwise provided in a coordinated set includes components such as one or more processors, data drives, and power supplies in order that each server may accomplish a fraction of the work intended for the whole. The coordinated set of servers may then be partitioned into multiple logical virtual machines, each of which can host the operating systems and applications of an individual user. One perceived advantage of virtualized servers is that the flexible allocation of server processing resources based on the processing requirements of each individual user helps to enhance the utilization and scalability of the server processing resources.

However, there are various economic and operational disadvantages of a virtualized server system. There can be a significant processing overhead associated with dynamically allocating server resources among many tens or hundreds of users. This overhead may reduce or eliminate the perceived utilization advantage provided by server resource allocation. Also, to coordinate processing at individual computer servers within a virtualized server, there can be a need for dedicated communication bandwidth between and localized switching at each individual computer server. This may increase both the cost and complexity of the hardware and software of each individual computer server.

There can also be significant cost and complexity associated with virtualized server redundancy. It is common to provide a fully redundant virtualized server so that if the active virtualized server fails or suffers degraded performance, some or all of the users can be switched to the standby virtualized server. But the cost of this redundancy is substantial, as the hardware configuration of the fully redundant virtualized server is typically similar to that of the active virtualized server. The associated requirements of switching many users at the same time and robustly detecting virtualized server failure scenarios that may impact a large number of users can increase the complexity of the control software, and the probability of failure of the software. In addition, the redundant power supply for the standby virtualized server typically runs at greater than 50% output to enable the switchover of a large processing load in the event of a failure of the active virtualized server. This can result in substantial additional heat generation per redundant virtualized server system, which can reduce the number of virtualized server systems that can be supported within a given data center.

Server size reduction is one approach commonly taken to achieve a higher density of computer servers per rack. For example, various computer servers can fit within a 1U form factor. To meet this decreasing server height requirement, computer components such as fans, drives, and power supplies have become progressively smaller. However, an associated cost is that the robustness, cooling efficiency, and maintainability of these reduced height units suffers.

One driver of the failure rate of servers is the failure rate of their moving components, such as fans and drives. As the size of these moving components decreases, the failure rate may tend to increase. The maintenance cost of these failures can be significant, often necessitating not only a site visit by a technician, but also replacement of the entire computer server.

Another driver of the failure rate of servers is the overheating of electronic components. The heat generated by servers may be increasing due in part to the increased heat generation of processors and power supplies as computing requirements increase. At the same time, the cooling efficiency of servers tends to decrease with reduced height. Fans having a 1U profile have extremely small fan blades and, accordingly, have limited air moving ability. It has been observed in some installations that a pair of 2U-sized fans can provide the same air moving capability as 10 1U-sized fans. Moreover, as server height decreases, there may be less interior space available for cooling airflow.

A higher computer server density can also create other maintainability problems. For example, the number of cables to route can increase. Cable routing complexity can also increase. For example, cables connecting a server near the top of a rack may span much of the width and height of the rack to connect to a switch deployed lower in the rack that can provide access to the Internet, a local area network, and/or a wide area network. For example, one common rack configuration includes one or more switches mounted near the middle of the rack, and computer servers mounted above and below the switches. Cables from each computer server may be routed first to the side of the rack and bundled. The cable bundles may then be routed vertically to the level of the mounted switches and unbundled. The individual cables may then be connected to individual switch ports. Also, handling the electromagnetic interference (EMI) generated by these cables can become more challenging.

In view of the foregoing problems, it would be desirable to provide improved techniques for grouping and combining components traditionally distributed across multiple computer servers to provide the performance of multiple computer servers with increased reliability and efficiency.

### SUMMARY OF THE INVENTION

In one innovative aspect, the invention relates to a computing apparatus. In one embodiment, the apparatus includes a chassis, a plurality of computing modules fixedly mounted in the chassis, and solid state electronic components in each of the plurality of computing modules, wherein any components with moving parts are exterior to the chassis.

In another innovative aspect, the invention relates to a rack-mounted computer system. In one embodiment, the rack-mounted computer system includes a rack, a plurality of grouped computing nodes including a first grouped computing node and a second grouped computing node, and a switch. Each of the plurality of grouped computing nodes is mounted in the rack and includes a chassis, a plurality of computing modules fixedly mounted in the chassis, and solid state electronic components including I/O interfaces in each of the plurality of computing modules. A first panel of the chassis is configured to provide access to the I/O interfaces. Any components with moving parts are exterior to the plurality of grouped computing nodes. The switch includes a second panel that is mounted adjacent to and between the first grouped computing node and the second grouped computing node, and that is configured to couple the first grouped computing node and the second grouped computing node.

In a further innovative aspect, the invention relates to a rack-mounted computer system. In one embodiment, the rack-mounted computer system includes a rack, a plurality of grouped computing nodes, and a power supply connected to each of the plurality of grouped computing nodes. Each of the plurality of computing nodes is mounted in the rack and includes a chassis, a plurality of computing modules fixedly mounted in the chassis, and solid state electronic components in each of the plurality of computing modules. Any components with moving parts are exterior to the plurality of grouped computing nodes. The rack and the plurality of grouped computing nodes cooperate to define a space in the rack adjacent to each of the plurality of grouped computing nodes into which cooling air flows from each of the plurality of grouped computing nodes.

### BRIEF DESCRIPTION OF THE DRAWINGS

For a better understanding of the nature and objects of the invention, reference should be made to the following detailed description taken in conjunction with the accompanying drawings, in which:

FIG. 1 illustrates a front perspective view of a grouped computing node including computing modules, in accordance with one embodiment of the present invention;

FIG. 2 illustrates a front perspective view of a grouped computing node including computing modules and hard disk modules, in accordance with one embodiment of the present invention;

FIG. 3 illustrates a view of a backplane of a grouped computing node with holes for airflow, in accordance with one embodiment of the present invention;

FIG. 4 illustrates a cutaway side view of a rack containing grouped computing nodes in a back-to-back configuration with representative airflow paths, in accordance with one embodiment of the present invention;

FIG. 5 illustrates a cutaway side view of a rack containing grouped computing nodes in a single stack configuration with representative airflow paths, in accordance with one embodiment of the present invention;

FIG. 6 illustrates a back perspective view of a rack containing grouped computing nodes in a single stack configuration, in accordance with one embodiment of the present invention;

FIG. 7 illustrates a top perspective view of a grouped computing node including computing modules, in accordance with one embodiment of the present invention;

FIG. 8 illustrates a front perspective view of a section of a rack containing two grouped computing nodes adjacent to a switch, in accordance with one embodiment of the present invention;

FIG. 9 illustrates a front perspective view of a rack filled with grouped computing nodes, each adjacent to a switch, in accordance with one embodiment of the present invention; and

FIG. 10 illustrates a top perspective view of a grouped computing node including a motherboard with switch fabric and extension slots containing computing modules, in accordance with one embodiment of the present invention.

### DETAILED DESCRIPTION OF THE INVENTION

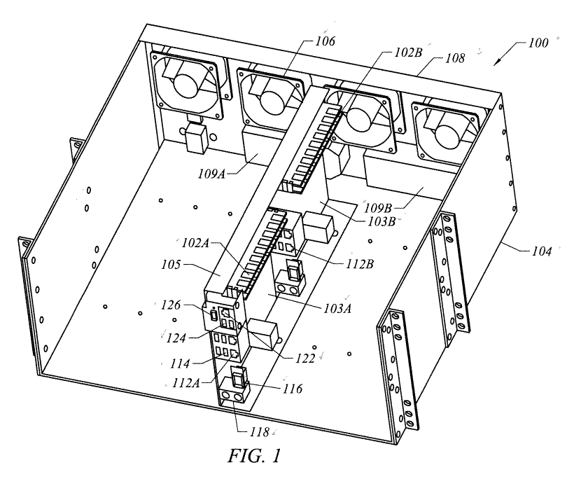

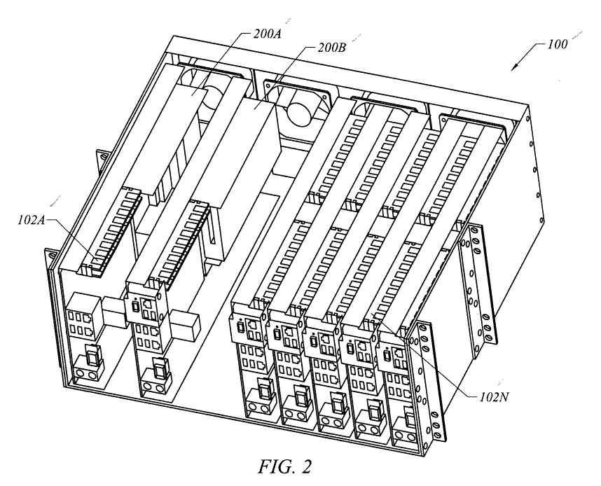

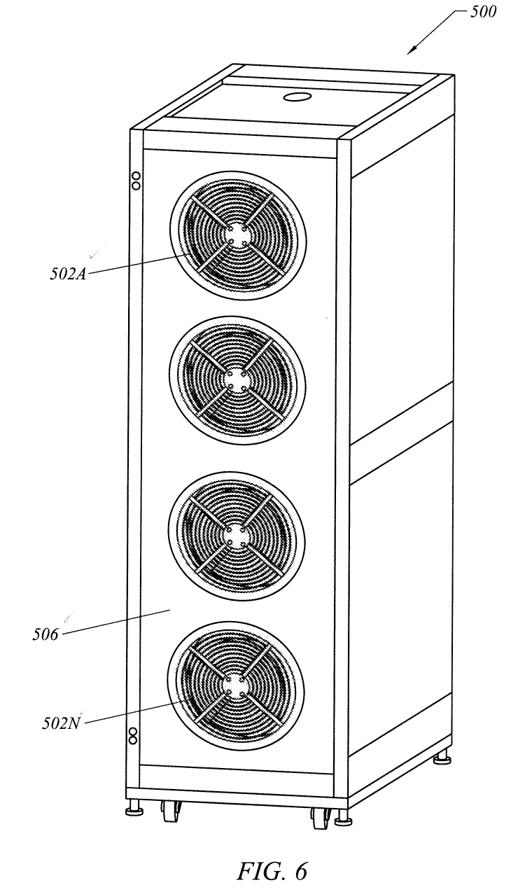

FIG. 1 illustrates a front perspective view of a grouped computing node 100 including computing modules 102A and 102B, in accordance with one embodiment of the present invention. The grouped computing node 100 may include a computer chassis 104 containing computing modules 102 and other components, such as one or more power supplies (illustrated in FIG. 6) and hard drives (illustrated in FIG. 2). Each computing module 102 may include any electronic system designed to perform computations and/or data processing. In some embodiments, the computing module 102 includes an electronic device having a central processing unit (CPU) and memory. The computing module 102 may be a computer server configured to respond to requests from at least one client. The computing module 102 may be provided on a board 103 that may be mounted in the computer chassis 104, such as onto a metal bracket 105. The computing module 102 may contain a system bus, processor and coprocessor sockets, memory sockets, serial and parallel ports, and peripheral controllers. This chassis 104 may include, for example, a housing that encloses all or portions of the computing modules 102. Alternatively, the chassis 104 may include a minimal structure, such as a tray or frame, which provides mechanical support for the computing modules 102. The chassis may also include fans 106. The fans 106 may be mounted on or attached to a back panel 108 of the chassis 104, so that the fans 106 correspond to holes in the hack panel 108. The chassis may also include a power supply 109. The power supply 109 may be a rectifier that converts an AC input to a DC output such as from 110V/220V AC in to at least 12V and 5V DC outputs. Alternatively, the power supply 109 may be a DC step-down voltage converter that may convert 48V DC in to 12V DC out. The power supplies 109A and 109B may be configured for redundancy, such as by connecting the power supplies 109A and 109B in parallel. In one embodiment, the grouped computing node 100 may be 4U or less in height, 15.5 inches or less in depth, and 17.6 inches or less in width.

In FIG. 1, each computing module 102 includes a plurality of I/O connectors mounted on a surface of the board 103 and located toward a front side of the board 103. The types of I/O connectors may vary depending on the configuration of the computing module 102, but may include, for example, one or more network connectors 112 (such as female RJ-45 connectors), one or more USB ports 114, one or more video ports 116 (such as DVI connectors), and mouse and/or keyboard ports 118 (such as AT or PS/2 connectors). The I/O connectors may further include, for example, a SCSI port, an ATA port, a serial port, an IEEE 1394 port, and a parallel port.

In FIG. 1, each metal bracket 105 has a pair of computing modules 102 mounted on it, one (102A) towards the front side of the chassis 104, and another (102B) towards the rear side of the chassis 104. In one representative embodiment, the chassis 104 is sized to fit ten metal brackets 105, and a total of twenty computing modules 102. Each metal bracket 105 also has a plurality of I/O connectors mounted on it. The types of I/O connectors may vary depending on the configuration of the computing modules 102, but may include, for example, one or more network connectors 122 (such as female RJ-45 connectors), one or more USB ports 124, and one or more video ports 126 (such as DVI connectors). The I/O connectors may further include any other type of I/O connector that may be mounted on a computing module 102. The purpose of the I/O connectors mounted on the bracket 105 is to enable access to I/Os of the rear computing module 102B from the front of the chassis 104. These I/O connectors may be cabled to the corresponding I/O connectors on the rear computing module 102B, which are adjacent to a rear side of the front computing module 102A. For example, the network connector 122 may be cabled to the corresponding network connector 112B of the rear computing module 102B.

FIG. 2 illustrates a front perspective view of the grouped computing node 100 including computing modules 102 and hard disk modules 200, in accordance with one embodiment of the present invention. In this example, the grouped computing node 100 includes twelve computing modules 102 and two hard disk modules 200, where the hard disk modules 200 are also mounted on brackets 105. The grouped computing node 100 is of course not restricted to this configuration, and may be flexibly configured to support various combinations of computing modules 102 and hard disk modules 200.

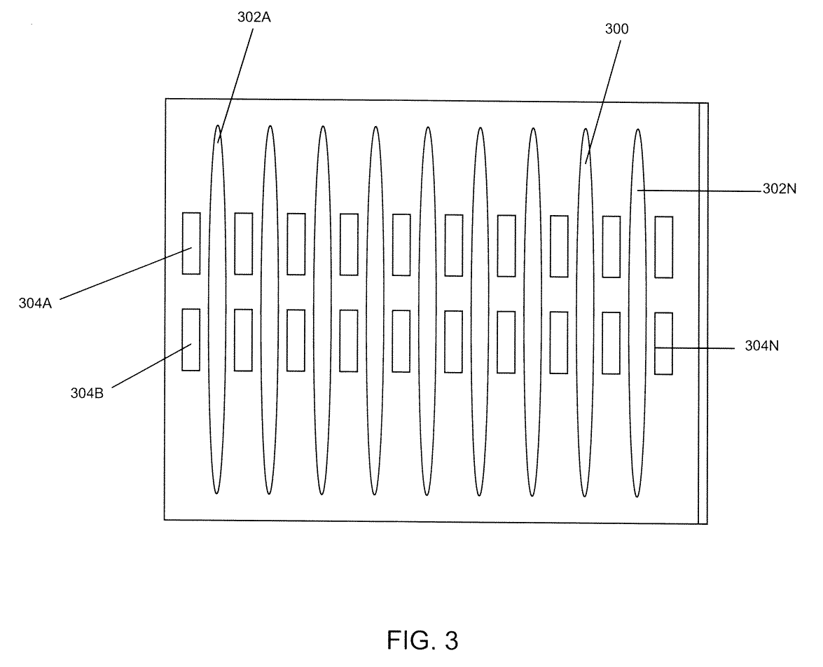

FIG. 3 illustrates a view of a backplane 300 of a grouped computing node 100 with apertures 302 for airflow, in accordance with one embodiment of the present invention. The backplane 300 may be a printed circuit board built into, mounted on, or attached to the back panel 108 of the chassis 104, so that the apertures 302 for airflow in the backplane 300 correspond to apertures, or holes, in the back panel 108. In this embodiment, the front computing module 102A and the rear computing module 102B may be cabled into connectors 304A and 304B mounted on the backplane 300. The shape and positioning of the apertures 302 for airflow may be different from that shown in FIG. 3.

An advantage of grouping and combining components traditionally distributed across multiple computer servers is increased reliability of systems using grouped computing nodes 100 over that of systems using traditional computer servers. One way to decrease the failure rate of grouped computing nodes 100 is to minimize or eliminate moving parts within the grouped computing nodes 100. In a preferred embodiment, a grouped computing node 100 includes only solid state electronic components, with no fans, hard drives, or removable drives. The grouped computing node 100 may, for example, include computing modules 102 and a voltage converter (illustrated in FIG. 6). Instead of fans, the grouped computing node 100 may include the backplane 300 with holes for airflow 302 corresponding to holes in the back panel 108, or may include the back panel 108 with the fans 106 removed, leaving holes for airflow. The elimination of moving parts within the grouped computing node 100 also may be combined with hardware redundancy (such as N+1 redundancy for the computing modules 102) and power supply redundancy. For example, one computing module 102 may be configured as a standby for each of the remaining computing modules 102. The reliability of the grouped computing node 100 may become so high as to make the grouped computing node 100 a disposable computing node that should not need any hardware replacement during the operating life of the grouped computing node 100.

In another embodiment, the grouped computing node 100 includes fans 106 but no hard drives or removable drives, as shown in FIG. 1. As the computing modules 102 are mounted vertically, the grouped computing node 100 substantially exceeds 1U in height. In one example, the grouped computing node 100 may be 4U in height. The increase in the size of the fans 106 as compared to fans used in conventional 1U servers significantly increases airflow through the chassis 104, which may reduce the probability of failure of the computing modules 102 due to overheating. Larger fans 106 may also be more mechanically reliable than 1U fans. The back panel 108 of the grouped computing node 100 may also be designed so that the fans 106 are removable and replaceable while the grouped computing node 100 remains in service.

In embodiments where hard drives are not included in the grouped computing node 100, the computing modules 102 may store substantially all information associated with clients served by the computing modules 102 in a storage device external to the grouped computing node 100. The computing modules 102 may interface with external disk arrays via I/O ports such as ATA ports. The external disk array may be mounted in the same rack as the grouped computing node 100, in a different rack at the same physical location, or may be in a different physical location from the grouped computing node 100.

In another embodiment, the grouped computing node 100 includes hard drives 200, as shown in FIG. 2. The grouped computing node 100 may include fans 106, the backplane 300 with holes for airflow 302 corresponding to holes in the back panel 108, or the back panel 108 with the fans 106 removed, leaving holes for airflow. Although the presence of hard drives 200 in the grouped computing node 100 may reduce the reliability of the grouped computing node 100 as compared to the above embodiments with no hard drives 200, the overall reliability of the grouped computing node 100 still exceeds that of conventional servers including both fans and hard drives.

Another advantage of grouped computing nodes 100 is greater processing efficiency. Each user environment may be supported by a separate computing module 102. In one embodiment, processing by each computing module 102 is independent of processing by the rest of the computing modules 102. This may be an attractive alternative to virtualized server systems, as the processing performance per unit price of multiple basic processors that do not support virtualization can outpace that of virtualized server systems.

Another advantage of grouped computing nodes 100 is more reliable and cost-effective redundancy. For example, if each user environment is supported by a separate computing module 102, then it may no longer be necessary to provide full 1+1 hardware redundancy. Rather, N+1 redundancy of computing modules 102 may be sufficient, which is a more cost-effective alternative. In addition, the control software for switching a single user in the event of a hardware or software failure may be significantly less complex than the control software for switching many users in the virtualized server system. This simplification of the control software may increase its reliability.

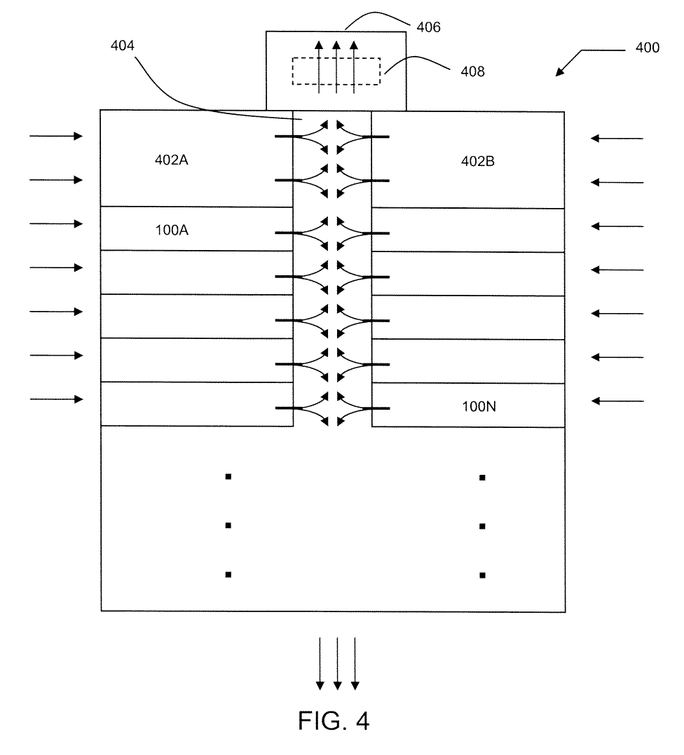

FIG. 4 illustrates a cutaway side view of a rack 400 containing grouped computing nodes 100 in a back-to-back configuration with representative airflow paths, in accordance with one embodiment of the present invention. Power supply modules 402 are shown at the top of the rack 400. In one embodiment, the chassis depth of the computing nodes 100 is 13.5 to 14.5 inches in a 30 inch deep rack, so that there is a back space 404 between 1 and 3 inches separating the back sides of the computing nodes 100. The power supply modules 402 have a similar depth so as to maintain the same back space 404 between the back sides of the power supply modules 402. FIG. 4 shows front-to-back airflow. Air travels from the environment, through the front of and between the grouped computing nodes 100, into the back space 404 and out of the rack 400. If fans 106 are included in the grouped computing nodes 100, the fan blades may be configured to facilitate front-to-back airflow. The power supply modules 402 may have similar fans. A vent in the form of a hood enclosure or plenum 406 optionally including fan(s) 408 may be provided to exhaust air heated by components within the computer to the exterior of the site at which the computers are located via ductwork or independently. The heated air may flow from the back space 404 of the rack 400 through the vent 406. Irrespective of its structure, in this variation of the invention, the vent 406 may be passive or utilize a partial vacuum generated by a fan or by some other means. Preferably, the air is exhausted from inside the rack 400 in an upward direction to take advantage of the buoyancy exhibited by heated air. It is, however, possible to vent the air from below or from above and below simultaneously.

In other embodiments, a positive airflow from above, below, or in both directions may be provided to the back space 404 of the rack 400. This will tend to force air from back to front through the grouped computing nodes 100. In this case, if fans 106 are included in the grouped computing nodes 100, the fan blades may be configured to facilitate back-to-front airflow. The power supply modules 402 may have similar fans.

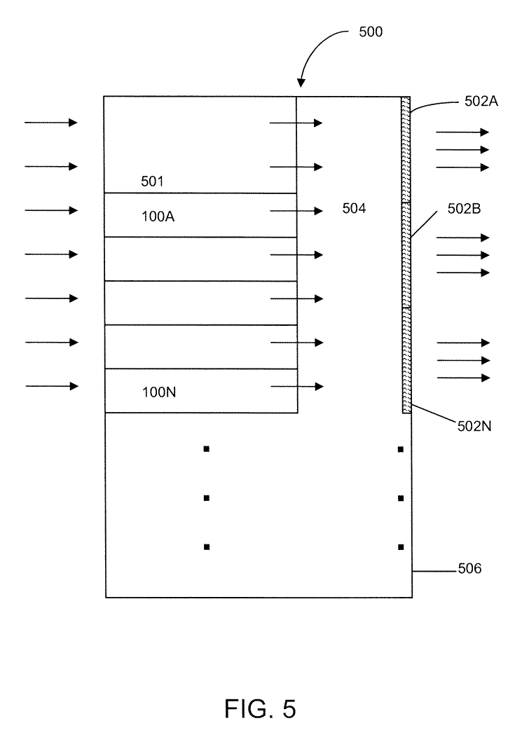

FIG. 5 illustrates a cutaway side view of a rack 500 containing grouped computing nodes 100 in a single stack configuration with representative airflow paths, in accordance with one embodiment of the present invention. Power supply module 501 is shown at the top of the rack 500. In one embodiment, the chassis depth of the computing nodes 100 is 27 to 29 inches in a 30 inch deep rack, so that there is a back space 504 between 1 and 3 inches separating the back side of the computing nodes 100 from the back panel 506 of the rack 500. The power supply module 501 has a similar depth so as to maintain the same back space 506 between the back side of the power supply module 501 and the back panel 506 of the rack 500. FIG. 5 shows front-to-back airflow. In this embodiment, fans 502 are mounted on or attached to the back panel 506 of the rack 500, so that air can be drawn out of the back space 504 by the fans 502. This creates a negative pressure region in the back space 504, so that air travels from the environment, through the front of and between the grouped computing nodes 100, and into the back space 504. The fans 502 are preferably at least 4U in diameter, and can eliminate the need for fans in the grouped computing nodes 100 and the power supply 501. As described previously, the increase in the size of the fans 502 as compared to fans used in conventional 1U servers significantly increases airflow through each grouped computing node 100 and the power supply 501, which may reduce the probability of failure of the computing modules 102 due to overheating. Larger fans 502 may also be more mechanically reliable than 1U fans. In addition, the placement of the fans 502 on the back panel 506 of the rack 500 make them easily replaceable in the event of a failure of one of the fans 502.

In one embodiment, the fans 502 may run at partial speed, such as 50% speed, in regular operating mode. The speed of one or more of the fans 502 may be adjusted up or down based on measurements such as temperature and/or air flow measurements in the back space 504, the power supply 501, and/or the computing modules 100. The failure of a fan 502A may be detected by a mechanism such as temperature and/or air flow measurement in the back space 504, the power supply 501, and/or the computing modules 100. In the event of such a failure, the speed of the fans 502 excluding the failed fan 502A may be adjusted up. The amount of this upward adjustment may be preconfigured and/or based on measurements such as temperature and/or air flow measurements in the back space 504, the power supply 501, and/or the computing modules 100. The amount of this upward adjustment may be constrained by the maximum operating speed of the fans 502. The higher speed is maintained until the failed fan 502A is replaced.

In one embodiment, the computing module 102A may be mounted toward the front side of the chassis 104 of the grouped computing node 100, and the computing module 102B may be mounted behind the computing module 102A, as shown in FIG. 1. This arrangement of computing modules 102 can increase the density of computing modules 102 within the chassis 104. At the same time, the increased heat dissipation due to this increased density can be handled by the increased cooling efficiency made possible by fans 106 and/or fans 502. In another embodiment, the computing module 102A may be mounted toward the front side of the chassis 104 of the grouped computing node 100, the computing module 102B may be mounted behind the computing module 102A, and one or more additional computing modules 102 may be mounted behind the computing module 102B, if allowed by space, cooling, and other design constraints.

FIG. 6 illustrates a back perspective view of a rack 500 containing grouped computing nodes 100 in a single stack configuration, in accordance with one embodiment of the present invention. In this embodiment, fans 502 are mounted on or attached to the back panel 506 of the rack 500, so that air can be drawn out of the back space 504 (illustrated in FIG. 5) by the fans 502.

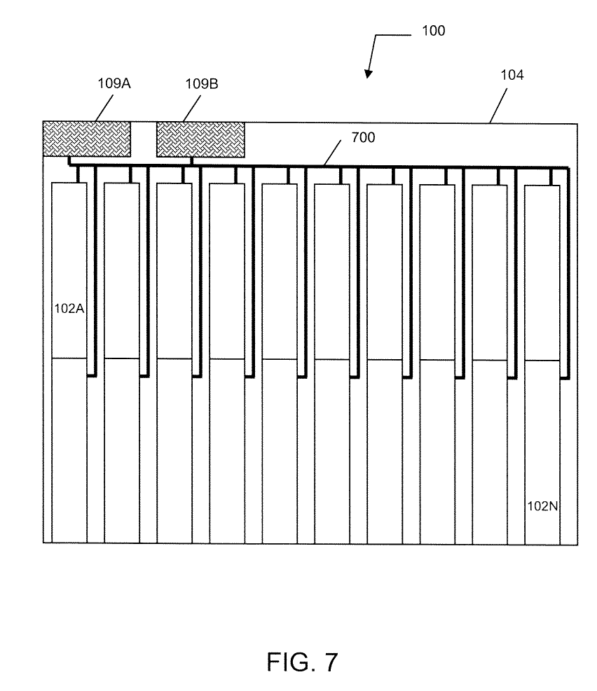

FIG. 7 illustrates a top perspective view of a grouped computing node 100 including computing modules 102, in accordance with one embodiment of the present invention. In this embodiment, there are 20 computing modules 102 mounted in the grouped computing node 100. The number of computing modules 102 may vary in other embodiments. Power supplies 109A and 109B may be placed at the top or the bottom of the chassis 104 of the grouped computing node 100, or anywhere else in the chassis 104 so as to minimize blockage of airflow through the chassis 104. Power supplies 109 are connected by the rails 700 to the computing nodules 102. The power supplies 109 may be connected in parallel to the rails 700 to provide power supply redundancy. In one embodiment, the rails 700 may include copper sandwiched around a dielectric, where the copper may be laminated to the dielectric. Also, each power supply 109 may have a single 12V DC output that branches out to multiple computing modules 102, as shown in FIG. 7, or alternatively may have multiple 12V DC outputs, where each 12V DC output is provided to one or more computing modules 102 using a separate rail. In addition, each power supply 109 may be configured with features such as other redundancy features, hot swappable features, hot-pluggable features, uninterruptible power supply (UPS) features, and load sharing with other power supplies 109. In this embodiment, each power supply 109 takes a 48V DC input from a power supply 402 or 501. The power supply 402 or 501 may be a rectifier that converts an AC input to a DC output, such as from 110V/220V AC in to a 48V DC output. If there are multiple power supplies 402 or 501 in a rack 400 or 500, the power supplies 402 or 501 may be configured to provide load sharing. If mounted in a rack 400 or 500, the grouped computing node 100 may access the 48V DC via a power supply line. The power supply line may extend vertically from each power supply 402 or 501 and provide an interface to each grouped computing node 100.

The computing modules 102 may include a voltage step-down converter to convert the 12V DC input from the rails 700 to at least 12V and 5V DC outputs. Alternatively, the computing modules 102 may be designed to use the 12V DC input directly, so that no additional voltage conversion stage is needed. This may help to save space on the computing modules 102.

If a computing module 102A includes a voltage step-down converter, the voltage step-down converter may be turned off to shut down the computing module 102A independently of the power supplies 109. In one embodiment, the voltage step-down converter may shut down the computing module 102A without turning off the power supplies 109 and affecting the concurrent operation of the other computing modules 102. Alternatively, if the computing module 102A does not include a voltage step-down converter, then a device such as a switch may be provided on the computing module 102A that can be turned off to shut down the computing module 102A independently of the power supplies 109. In one embodiment, the switch may shut down the computing module 102A without turning off the power supplies 109 and affecting the concurrent operation of the other computing modules 102.

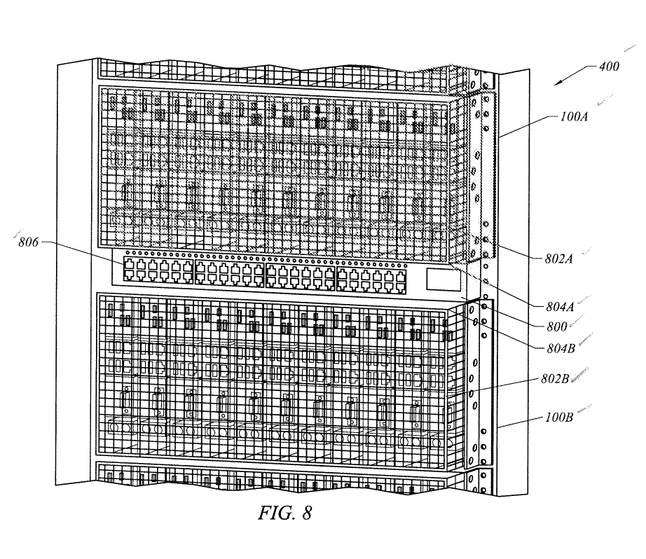

FIG. 8 illustrates a front perspective view of a section of a rack 400 containing two grouped computing nodes 100A and 100B adjacent a switch 800, in accordance with one embodiment of the present invention. Each grouped computing node 100 includes a bezel 802 that is adjacent to and substantially covers the front panel of the grouped computing node 100, including the I/O interfaces of the computing modules 102 within the grouped computing node 100. The front panel of the grouped computing node 100 is configured to provide access to the I/O interfaces of the computing modules 102. The bezel 802 may be removable or pivotally mounted to enable the bezel 802 to be opened to provide access to the grouped computing node 100. The bezel 802 may function to reduce the effect of electromagnetic interference (EMI), to protect the I/O interfaces and associated cabling, to minimize the effect of environmental factors, and to improve the aesthetic appearance of the grouped computing node 100. Although the bezel 802 may extend across the front panel of the grouped computing node 100, the bezel 802 may be formed as a grid with spaces that allow cooling airflow to the grouped computing node 100.

In one embodiment, the height of the switch 800 is 1U and the height of each grouped computing node is 4U. The bezels 802A and 802B may be reversibly mounted so that the protruding edge 804A of the bezel 802A extends down toward the switch 800, and the protruding edge 804B of the bezel 802B extends up toward the switch 800. The protruding edge 804A of the bezel 802A may extend down an additional 0.5U and the protruding edge 804B of the bezel 802B may extend up an additional 0.5U to substantially cover the front panel of the switch 800. Alternatively, the front panel of the switch 800 may be substantially covered by a transparent material that serves as a window for the front panel of the switch 800. The transparent material may attach to the bezels 802A and 802B, or may be combined with bezels 802A and 802B into a single cover for the grouped computing nodes 100A and 100B and the switch 800.

In one embodiment, at least one data port 806 of the switch 800 is available for each computing module 102 within the grouped computing node 100A mounted directly above the switch 800 and the grouped computing node 100B mounted directly below the switch 800. In FIG. 8, each grouped computing node 100 contains 20 computing modules 102 (in a configuration such as that illustrated in FIG. 7), and the switch 800 contains 48 data ports 806, which is sufficient to provide one data port 806 to each of the 20 computing modules contained in each of grouped computing nodes 100A and 100B. The I/O interfaces of the grouped computing nodes 100A and 100B may be cabled to the nearest data ports 806 of the switch 800.

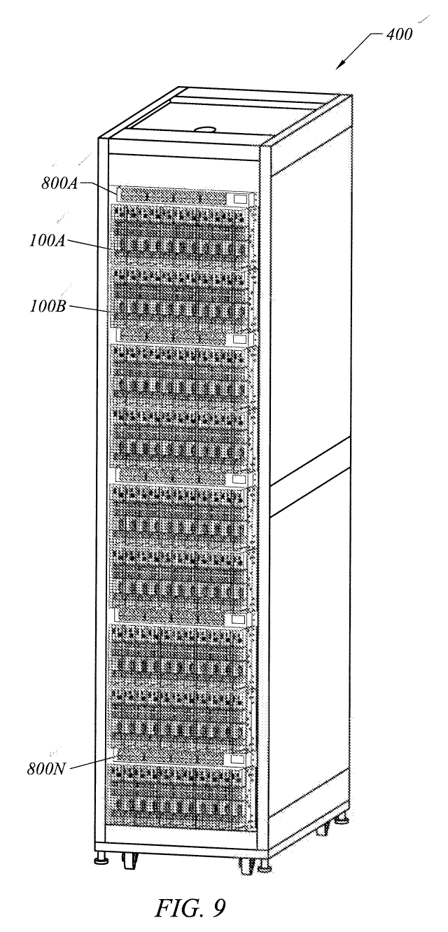

There are several advantages of the configuration of FIG. 8. The grouped computing nodes 100A and 100B and the switch 800 may be pre-configured to speed up deployment in the configuration of FIG. 8. The configuration of FIG. 8, if repeated through a rack 400 as shown in FIG. 9, also simplifies cable routing relative to a configuration in which computing nodes 100 fill the upper and lower portions of the rack 400, and switches 800 fill the middle portion of the rack 400. FIG. 9 illustrates a front perspective view of a rack 400 filled with grouped computing nodes 100, each adjacent to a switch 800, in accordance with one embodiment of the present invention. In FIG. 9, the I/O interfaces of each grouped computing node 100 may be cabled to a data port 806 of the nearest switch 800.

There are at least the following additional advantages of the configuration of FIG. 8. The availability of the switch 800 may eliminate the need for a switch on each computing module 102, which would reduce the power consumption and heat dissipation of each computing module 102, and which would make additional space available on each computing module 102. Buying a large switch 800 off-the-shelf can decrease the cost per switch port as compared to buying a smaller switch for each of the computing modules 102. Also, the previously described configurations of the bezels 802A and 802B that cover the switch 800 serve at least the combined functions of covering the ports 806, covering the connecting cables from the grouped computing nodes 100A and 100B to the switch 800, and reducing the effect of electromagnetic interference (EMI) from the grouped computing nodes 100A and 100B, the switch 800, and their connecting cables.

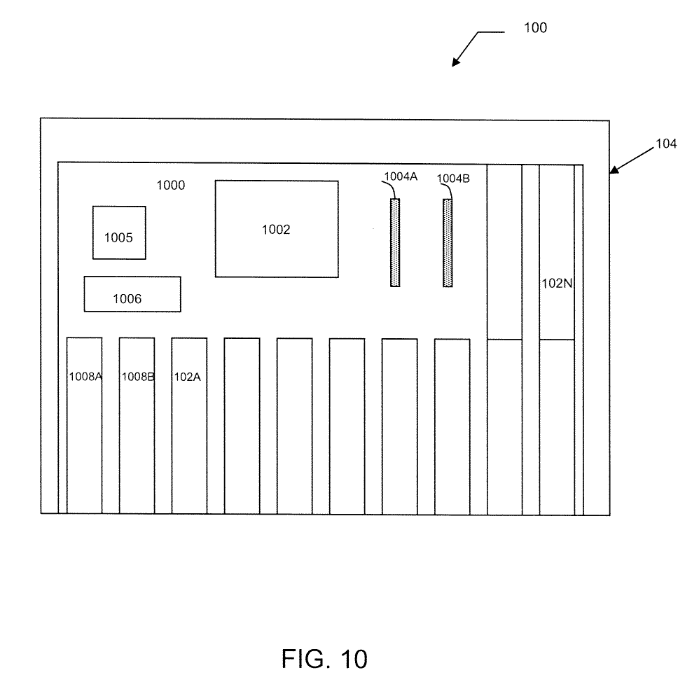

FIG. 10 illustrates a top perspective view of a grouped computing node 100 including a motherboard 1000 with switch fabric 1002 and extension slots 1004 including computing modules 102, in accordance with one embodiment of the present invention. The motherboard 1000 may be inserted in the lower portion of the chassis 104 of the grouped computing node 100. The motherboard 1000 may include components such as a CPU 1005, memory 1006, and a switch fabric 1002. In addition, the motherboard 1000 includes a plurality of extension slots 1004. The extension slots 1004 may include Peripheral Component Interconnect (PCI) slots. Conventional I/O extension modules such as sound or video cards may be inserted into extension slots 1004. Computing modules 102 may also be inserted into extension slots 1004. Data from a computing module 102A may be transmitted to the switch fabric 1002, switched by the switch fabric 1002, and received by another computing module 102B. This data may include Ethernet data frames received, processed, and/or generated by the computing module 102A.

Advantages of the configuration of FIG. 10 include that switching is provided within the grouped computing node 100, which may reduce the external cabling to and from the grouped computing node 100, reduce EMI, and speed up deployment time. The availability of the switch fabric 1002 may eliminate the need for a switch on each computing module 102, which would reduce the power consumption and heat dissipation of each computing module 102, and which would make additional space available on each computing module 102. Buying a switch fabric 1002 off-the-shelf can also decrease the cost per switch port as compared to buying a smaller switch for each of the computing modules 102.

The figures provided are merely representational and may not be drawn to scale. Certain proportions thereof may be exaggerated, while others may be minimized. The figures are intended to illustrate various implementations of the invention that can be understood and appropriately carried out by those of ordinary skill in the art.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

What is claimed is:

1. An apparatus, comprising:
a chassis;
a plurality of computing modules fixedly mounted in the chassis; and
solid state electronic components in each of the plurality of computing modules;
wherein any components with moving parts are exterior to the chassis.

2. The apparatus of claim 1, wherein:
each of the plurality of computing modules is a computer server configured to respond to requests from at least one client;
processing by each of the plurality of computing modules is independent of processing by the rest of the plurality of computing modules.

3. The apparatus of claim 2, wherein each of the plurality of computing modules stores substantially all information associated with the at least one client in a storage device external to the chassis.

4. The apparatus of claim 1, further comprising a plurality of apertures in a panel of the chassis configured so that cooling air can flow between the plurality of computing modules and through the plurality of apertures.

5. The apparatus of claim 1, wherein:
the solid state electronic components include a printed circuit board, a processor, memory, and I/O interfaces; and
each of the plurality of computing modules includes:
a first side at which the I/O interfaces are located; and
a second side opposite the first side.

6. The apparatus of claim 5, wherein the plurality of computing modules is divided into a plurality of groups of at least two computing modules including a first computing module and a second computing module, wherein the I/O interfaces of the first computing module are adjacent to the second side of the second computing module.

7. The apparatus of claim 6, wherein the I/O interfaces of the first computing module are coupled to I/O interfaces mounted on a bracket to which the second computing module is mounted.

8. The apparatus of claim 5, further comprising:
a first panel of the chassis configured to provide access to the I/O interfaces of the plurality of computing modules; and
a bezel substantially covering the first panel.

9. The apparatus of claim 1, further comprising a first computing module that is configured as a standby for each of the plurality of computing modules.

10. The apparatus of claim 1, further comprising:
a first power supply and a second power supply connected in parallel to each of the plurality of computing modules;
wherein each of the plurality of computing modules includes a device that turns off each of the plurality of computing modules, and that operates independently of the first power supply and the second power supply.

11. The apparatus of claim 1, further comprising:
a switching module coupling the plurality of computing modules; and
a printed circuit board including an extension slot into which one of the plurality of computing modules can be inserted.

12. A rack-mounted computing system, comprising:
a rack;
a plurality of grouped computing nodes including a first grouped computing node and a second grouped computing node, wherein each of the plurality of grouped computing nodes is mounted in the rack and includes:
a chassis;
a plurality of computing modules fixedly mounted in the chassis;
solid state electronic components including I/O interfaces in each of the plurality of computing modules; and
a first panel of the chassis configured to provide access to the I/O interfaces;
wherein any components with moving parts are exterior to the plurality of grouped computing nodes; and
a switch including a second panel that is mounted adjacent to and between the first grouped computing node and the second grouped computing node, and that is configured to couple the first grouped computing node and the second grouped computing node.

13. The rack-mounted computer system of claim 12, further comprising a cover adjacent to and substantially covering the first panel of the first grouped computing node, the first panel of the second grouped computing node, and the second panel of the switch.

14. The rack-mounted computing system of claim 13, wherein the cover includes a first bezel adjacent to and substantially covering the first panel of the first grouped computing node, a second bezel adjacent to and substantially covering the first panel of the second grouped computing node, and a transparent material adjacent to and substantially covering the second panel of the switch.

15. A rack-mounted computing system, comprising:
a rack;
a plurality of grouped computing nodes mounted in the rack, wherein each of the plurality of grouped computing nodes includes:
a chassis;
a plurality of computing modules fixedly mounted in the chassis; and
solid state electronic components in each of the plurality of computing modules;
wherein any components with moving parts are exterior to the plurality of grouped computing nodes; and
a power supply connected to each of the plurality of grouped computing nodes;
wherein the rack and the plurality of grouped computing nodes cooperate to define a space in the rack adjacent to each of the plurality of grouped computing nodes into which cooling air flows from each of the plurality of grouped computing nodes.

16. The rack-mounted computing system of claim 15, further comprising a plenum extending from the rack, wherein the cooling air flows from the space out of the rack through the plenum.

17. The rack-mounted computing system of claim 16, wherein at least two of the plurality of grouped computing nodes are provided in a back-to-back configuration in the rack.

18. The rack-mounted computing system of claim 15, further comprising a plurality of fans mounted in a panel of the rack adjacent to the space, wherein the plurality of fans draw the cooling air out of the rack.

19. The rack-mounted computing system of claim 18, wherein a speed of at least one of the plurality of fans is modified based on at least one of temperature measurements and air flow measurements in at least one of the space, the power supply, and at least one of the plurality of grouped computing nodes.

20. The rack-mounted computing system of claim 18, wherein a diameter of at least one of the plurality of fans is at least 4U.
